(19) United States
(12) Patent Application Publication
(10) Pub. No.: US 2025/0245077 A1
(43) Pub. Date: Jul. 31, 2025

(54) Cached Variables For Event Management

(71) Applicant: PagerDuty, Inc., San Francisco, CA (US)

(72) Inventors: Alison Jane Warner, Portland, OR (US); Marcos Eric Wright-Kuhns, Portland, OR (US); Francis Edmund Emery, Toronto (CA)

(21) Appl. No.: 18/427,956

(22) Filed: Jan. 31, 2024

(51) Int. Cl. G06F 9/54

(52) U.S. Cl. CPC G06F 9/542

(57) ABSTRACT

A definition of a cached variable is associated with an event management orchestration. The definition identifies the cached variable as a counter of events that meet predefined criteria. A time-series data structure is associated with the cached variable. Timestamp data are stored in the time-series data structure based on received events that meet the predefined criteria. The stored time-series data are used to obtain a count value of the cached variable. The count value is used by the event management orchestration to determine a processing or a subsequent event to the received events.

### TECHNICAL FIELD

This disclosure relates generally to computer operations and more particularly, but not exclusively, to cached variables for injecting contextual memory into event management.

### SUMMARY

A first aspect of the disclosed implementations is a method that includes associating a definition of a cached variable with an event management orchestration, where the definition identifies the cached variable as a counter of events that meet predefined criteria; associating a time-series data structure with the cached variable; storing timestamp data in the time-series data structure based on received events that meet the predefined criteria; and using the stored time-series data to obtain a count value of the cached variable, where the count value is used by the event management orchestration to determine a processing or a subsequent event to the received events.

A second aspect of the disclosed implementations is a system that includes one or more memories and one or more processors. The one or more processors are configured to execute instructions stored in the memory to associate a definition of a cached variable with an event management orchestration, where the definition identifies the cached variable as a counter of events that meet predefined criteria; associate a time-series data structure with the cached variable; store timestamp data in the time-series data structure based on received events that meet the predefined criteria; and use the stored time-series data to obtain a count value of the cached variable, where the count value is used by the event management orchestration to determine a processing or a subsequent event to the received events.

A third aspect of the disclosed implementations is on-transitory computer readable media that store instructions operable to cause one or more processors to perform operations that include associating a definition of a cached variable with an event management orchestration, where the definition identifies the cached variable as a counter of events that meet predefined criteria; associating a time-series data structure with the cached variable; storing timestamp data in the time-series data structure based on received events that meet the predefined criteria; and using the stored time-series data to obtain a count value of the cached variable, where the count value is used by the event management orchestration to determine a processing or a subsequent event to the received events.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of a system for generating incident status reports.

FIG. 5 is a block diagram of a system where cached variables can be used.

FIGS. 6A-6F illustrate user interfaces for configuring orchestration rules to use cached variables.

FIG. 7 is an example of a technique for using cached variables in orchestration rules.

FIG. 8 is a flowchart of an example of a technique for using time series as a counter in event management.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to an information technology (IT) service of an organization. An event can be or describe a fact at a moment in time that may consist of a single or a group of correlated conditions that have been monitored and classified into an actionable state. As such, a monitoring tool of an organization may detect a condition in the IT environment (e.g. such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 503 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires the performance (by a human or an automated task) of an action. Thus, the alert may embody or include the action to be performed.

An incident associated with an alert may or may be used to trigger a notification to the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

Incident responders may be required to provide incident status updates to various stakeholders. These stakeholders may include internal colleagues, team members, end-users, executives, external customers, or other stakeholders. These incident status updates are typically dispatched during the lifecycle of an incident—while the underlying issue is ongoing and the incident is unresolved—and also when the incident has been resolved.

In the context of event or incident management, “contextual memory” (also referred to herein as “system state,” “system memory,” or “event history”) may refer to the capacity of the EMB to recall past events (e.g., data related thereto) during the processing of an incoming event. Contextual memory can improve the decision quality (e.g., the processing) associated with an incoming event. The absence of such contextual memory can lead to inefficient event processing and a lack of situational awareness, potentially resulting in suboptimal event or incident management and/or resolution.

The absence of contextual memory may present several challenges. For instance, the limited capability to contextualize current events based on historical data may lead to repetitive or unnecessary alarms, causing user alert fatigue and unnecessary computational resource usage. Secondly, the ability to recognize patterns and trends over time may be hindered where these patterns and trends can be useful in proactive issue resolution and prevention. Lastly, without historical data (i.e., contextual memory), the EMB may not effectively prioritize events or optimize responses based on past events, leading to less efficient incident management.

Traditional techniques for injecting contextual memory into the processing of an incoming event may include performing, during the processing of the incoming event, time-consuming queries to data stores holding past events therewith incurring delays to the processing of the incoming event. Another approach may involve collecting events outside of the EMB (e.g., withholding the transmission of these events) until conditions of interest are identified or met. Such an approach also causes delays in event processing.

In certain situations and environments, delays in event processing may not be tolerable or acceptable. Meeting stringent service level agreements (SLAs), especially in high-velocity environments like the EMB, necessitates quick event processing (e.g., sub-second response times). Under such stringent SLAs, conventional systems often operate in a memoryless manner handling each event in isolation without considering historical context. This approach can lead to inefficiencies and missed opportunities for more nuanced and/or targeted responses.

As such, fast processing, combined with contextual memory, facilitates more precise and dynamic decision-making. However, the conventional approaches to injecting contextual memory into event management can be slow and inefficient, particularly in high-volume scenarios where speed is essential. Additionally, the conventional approaches may not scale well, struggling under heavy loads or requiring significant resources to maintain performance. Injecting contextual memory while adhering to requisite response times may involve substantially increased investment in processing and memory resources therewith resulting in increased energy expenditures (needed to operate those increased processing and memory resources) and associated emissions that may result from the generation of that energy.

Cached variables solve problems such as these by providing a means of injecting contextual memory into event management (e.g., processing) without noticeably increasing event processing times. Processing cached variables may add a negligible time (e.g., on the order of five to ten microseconds) to the processing of an incoming event. Cached variables can be used to store and reference event-related data over a short period. Cached variables act as memory, holding data relevant to recent events (such as for a specified duration). They enable event management systems, such as an EMB, to make informed decisions based on recent history without the overhead of conventional techniques.

Cached variables are extracted during event processing, storing key information such as event counts or other event attributes. The data can then be used in subsequent event evaluations, allowing the system to respond dynamically based on recent occurrences. For instance, a cached variable could track the number of errors within a specific timeframe, enabling the system to escalate its response if a threshold is exceeded. This approach enhances the effectiveness of the EMB, enabling faster, more context-aware processing while avoiding the pitfalls of more cumbersome, traditional memory-integrating techniques.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, received, etc.) by an event management bus. An event management bus (which can also be referred to as an event ingestion and processing system) may be configured to monitor various types of events depending on the needs of an industry and/or technology area. For example, IT services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof. An event (e.g., an event object) may be directly created (such as by a human) in the EMB via user interfaces of the EMB.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder,” as used herein, can refer to a person or entity, represented or identified by persons, that may be responsible for responding to an event associated with a monitored application or service. A responder is responsible for responding to one or more notification events. For example, responders may be members of an IT team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or systems for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

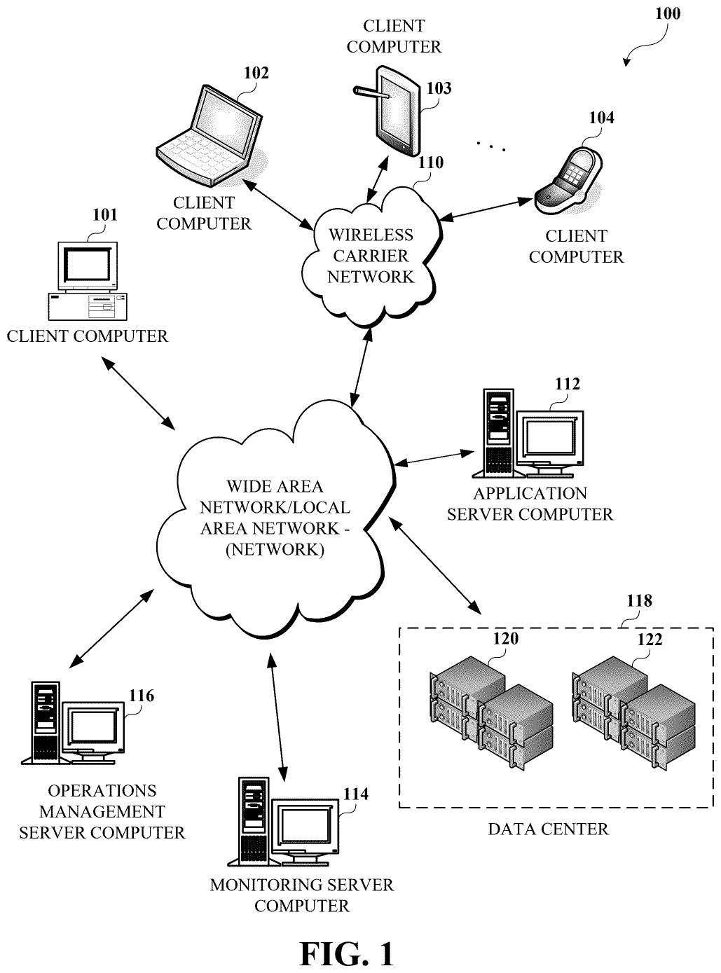

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include the capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanisms and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

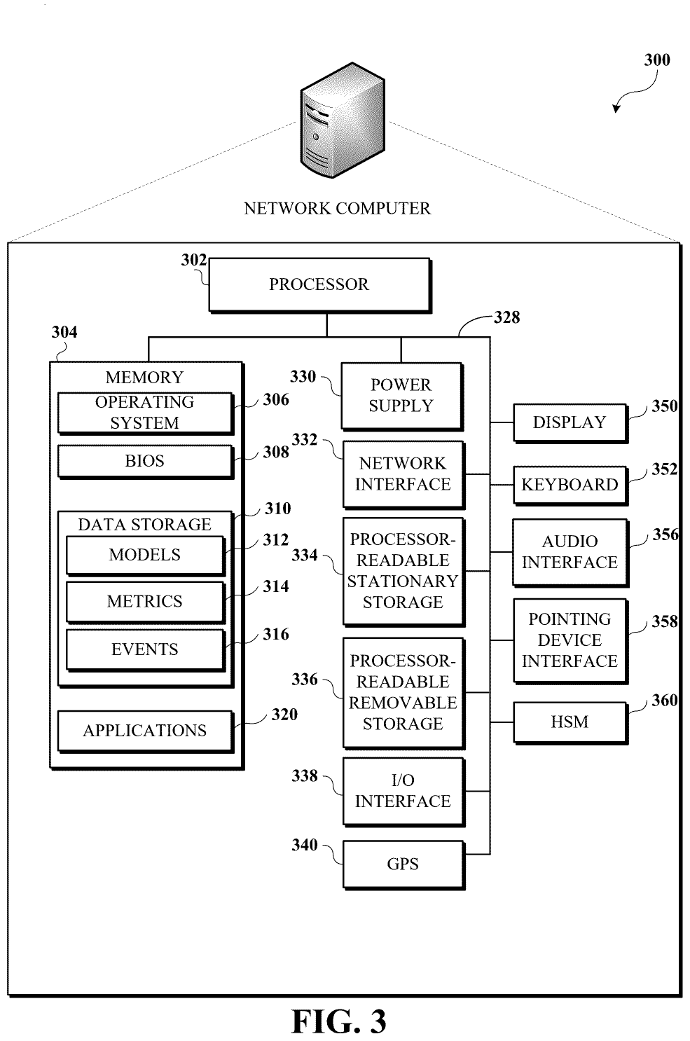

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

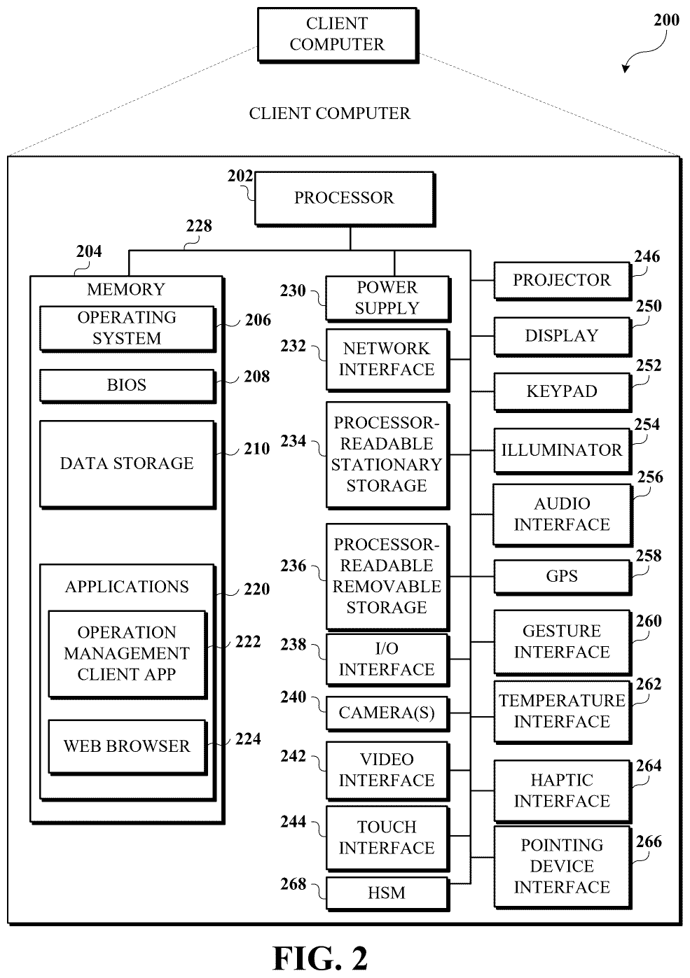

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measure or maintain an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™ Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for orchestration rule evaluation and cached variables management. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, at least some of the applications 320 may be operative in a cloud-based computing environment. In at least one of the various embodiments, these applications, and others, that include the management platform may be executing within virtual machines or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to at least some of the applications 320 may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces as well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 108 or the network 111.

Also, in at least one of the various embodiments, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

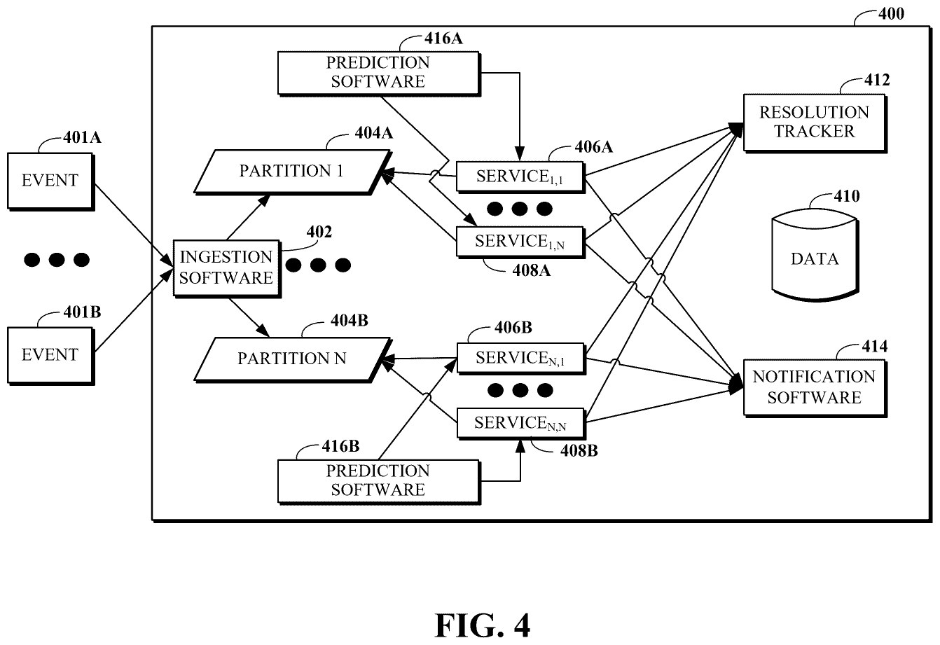

FIG. 4 illustrates a logical architecture of a system 400 for generating incident status reports. In at least one of the various embodiments, a system for automatically generating smart incident status updates may include various components. In this example, the system 400 includes an ingestion software 402, one or more partitions 404A-404B, one or more services 406A-406B and 408A-408B, a data store 410, a resolution tracker 412, a notification software 414, and a status reporting software 416.

One or more systems, such as monitoring systems, of one or more organizations may be configured to transmit events to the system 400 for processing. The system 400 may provide several services. A service may, for example, process an event and determine whether a downstream object (e.g., an incident) is to be triggered. As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by the same service would include two different routing keys. A routing key may be unique to the service that is to receive and process an event. As such, two events associated with two different routing keys and received from the same managed organization for processing may be directed to (e.g., processed by) different services.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the system 400 so that the system 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion software 402 may be arranged to normalize incoming events into a unified common event format. Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406B and 408A-408B may perform different logic as appropriate for the events processed by the service.

An event may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated metadata, such as, a title (or subject), a source, a creation time stamp, a status indicator, a region, more information, fewer information, other information, or a combination thereof, that may be tracked. In an example, the event data may be received as structured data, which may be formatted using JavaScript Object Notation (JSON), XML, or some other structured format. The metadata associated with an event is not limited in any way. The metadata included in or associated with an event can be whatever the sender of the event deems required.

In at least one of the various embodiments, a data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the system 400 received, such as from the integration, an event indicating that a previous event, which triggered the alert, is resolved. The integration may be a monitoring system.

The data store 410 can be used to store, inter alia, incident data. An incident may be represented as an object in the data store 410. For brevity, an incident object is simply referred to as an incident. In an example, the incident data may be notes (textual or otherwise) entered in association with the incident by responders. The incident data may include an association to one or more responders, such as those assigned to the incident. The set of notes associated with an incident may be referred to as an incident timeline. In an example, at least some of the notes of the incident timeline may be programmatically obtained, by one or more components of the system 400, from other systems. The data store 410 can include data usable by the status reporting software 416 to generate incident status reports. The data usable by the status reporting software 416 can include template, training data, prompts, rules, and the like usable by the status reporting software 416 to configure a language model tool, as further described herein.

In at least one of the various embodiments, the resolution tracker 412 may be arranged to monitor the details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may be associated with one resolution tracker. Other configurations or mappings between partitions, services, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification software 414 may generate one or more notification messages and determine a particular message provider to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification software 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured.

In at least one of the various embodiments, the system 400 may include various user-interfaces or configuration information (not shown) that enable organizations to establish how events should be resolved. Accordingly, an organization may define rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if an object matches the template, then the tasks of the runbook can be performed (e.g., executed, orchestrated, etc.) according to the order, rules, and/or workflow specified in the runbook. In another example, the runbook can be associated with a type. As such, if an object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding objects and/or groups of objects. For example, a responder can use one of the user interfaces to obtain information regarding incidents assigned to or acknowledged by the responder. A user interface can be used to obtain information about an incident including the events (i.e., the group of events) associated with the incident. In an example, the responder can use the user interface to obtain information from the system 400 regarding the reason(s) a particular event was added to the group of events.

At least one of the services 406A-406B and 408A-408B may be configured to trigger alerts. A service can also trigger an incident from an alert, which in turn can cause notifications to be transmitted to one or more responders.

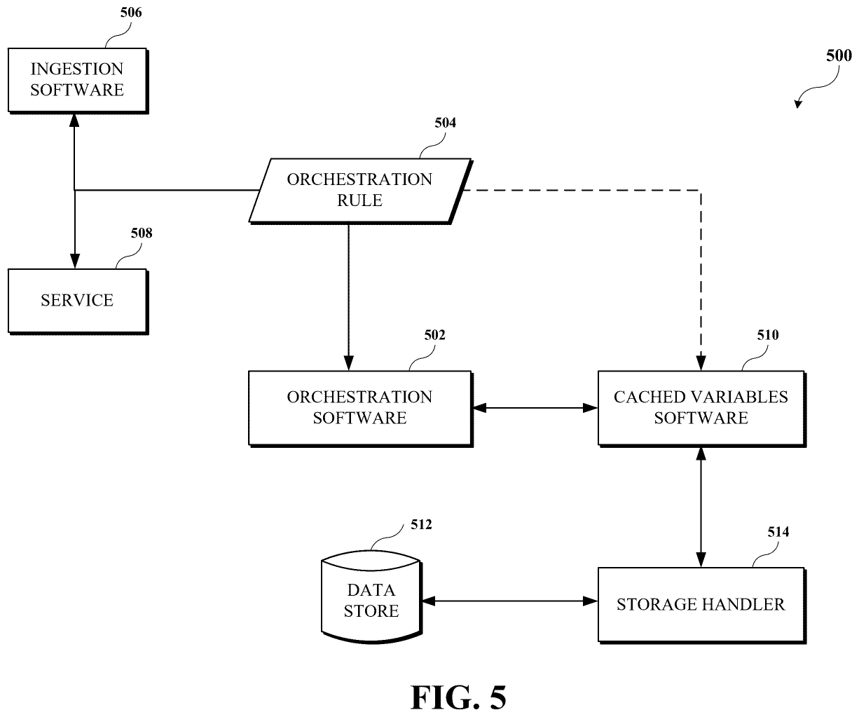

FIG. 5 is a block diagram 500 of a system where cached variables can be used. The block diagram 500 includes an orchestration software 502 usable for associating orchestration rules, such as an orchestration rule 504, with a service 508 or with an ingestion software 506. The service 508 can be one of the services 406A, 406B, 408A, or 408B of FIG. 4. The ingestion software 506 can be the ingestion software 402 of FIG. 4.

Each of the orchestration software 502, the cached variables software 510, and the storage handler 514 may be or include respective one or more programs, subprograms, functions, routines, subroutines, operations, executable instructions, and/or the like (collectively, “tools”) for, inter alia and as further described, event orchestration using cached variables. At least some of the tools can be implemented as respective software programs that may be executed by one or more computing devices, such as the network computer 300 of FIG. 3. A software program can include machine-readable instructions that may be stored in one or more memories such as one or more of the memory 304, and that, when executed by one or more processors, such as the processor 302 of FIG. 3, may cause the computing device to perform the instructions of the software program.

Orchestration rules (which may also be referred to as workflows) can be used (such as an administrator or a privileged person) to define (e.g., configure, set up, etc.), actions based on event content thereby automating the processing and routing of incoming events. Orchestration, in this context, refers to the ability to configure automated processing and routing of incoming events via custom logic and conditions to optimize the processing of events. An orchestration rule associated with the ingestion software 506 may be referred to as a global orchestration rule; and an orchestration rule associated with the service 508 may be referred to as a service orchestration rule. One type of global orchestration rules can be used to configure actions that apply regardless of destination service of an event. Such global orchestration rules may be used, for example, to change an incident title, to perform an automation action, or to set incident priority. Another type of global orchestration rules may be referred to as router rules and can be used to route events to services. For example, if an event matches certain conditions of a routing rule, the event is routed to a specific service for further processing.

When an incoming event stream can have more than one service destination (e.g., can be routed to more than one service), global orchestrations rule can be used to apply event actions and route the events to different services. To illustrate, and without limitation, assume that a first service is configured to receive (and process) events related to database issues and a second service is configured to receive (and process) events related to front-end issues of an application. A global orchestration rule may be associated with the ingestion software 506 so that, when an event is first ingested, the global orchestration rule can be evaluated to examine the event (e.g., payload or metadata associated therewith) to determine whether to route the event to the first service or to the second service.

As mentioned above, events are to be processed expeditiously within predefined SLA parameters. Accordingly, orchestration rules are to be evaluated (e.g., performed or evaluated) to ensure minimal processing latency. Orchestration rules, and by extension, the orchestration software 502 which evaluates them, are architected to function within a controlled environment or sandbox. This restrictive environment limits the interactions of the orchestration software 502 with broader capabilities or an EMB, such as the system 400 of FIG. 4. To illustrate, in contrast to systems not bound by stringent SLAs, which may afford the flexibility to perform database queries, such as retrieving historical event data from a data store, the orchestration software 502 is, by design, not enabled (e.g., programmed) to be configurable with such resource-intensive operations. Operations such as data queries, or other time consuming operations (such as API calls), are not possible in the orchestration software 502 to comply with the performance criteria set by the SLAs, thus optimizing efficiency.

A cached variables software 510 is used in conjunction with the orchestration software 502 to enhance event management by injecting (e.g., incorporating) event history (e.g., contextual memory) into event management, thereby enriching the context for decision-making. Cached variables enable the aggregation or retrieval of event history data based on incoming events. Processing of subsequent events can use the event history data. Practically, upon receipt of an event (by the ingestion software 506 or the service 508, as the case may be), the cached variables software 510 may obtain values of cached variable to process the event as the event proceeds through immediate processing (for example, by an orchestration rule). After the event is processed, the orchestration software 502 may extract pertinent data from the event and preserve that data. The preserved event history can be used in the processing of subsequent events, thereby enabling more informed decision-making (such as improved routing or action determination) for those events. Cached variables thus provide a dual advantage: they ensure that the system 400 retains necessary processing velocity to meet event management performance criteria, while simultaneously infusing a degree of contextual memory (i.e., leveraging event history) into event management.

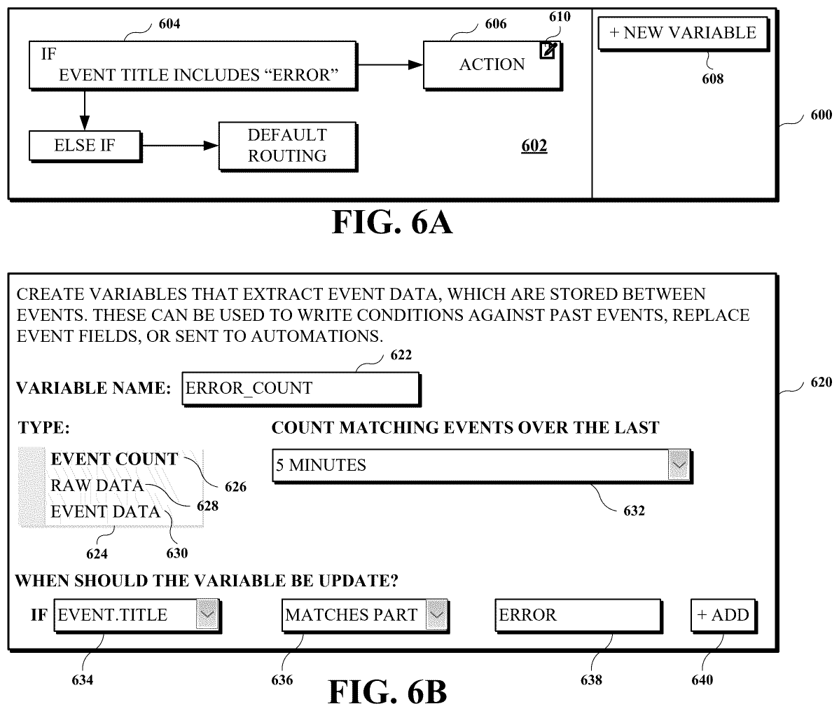

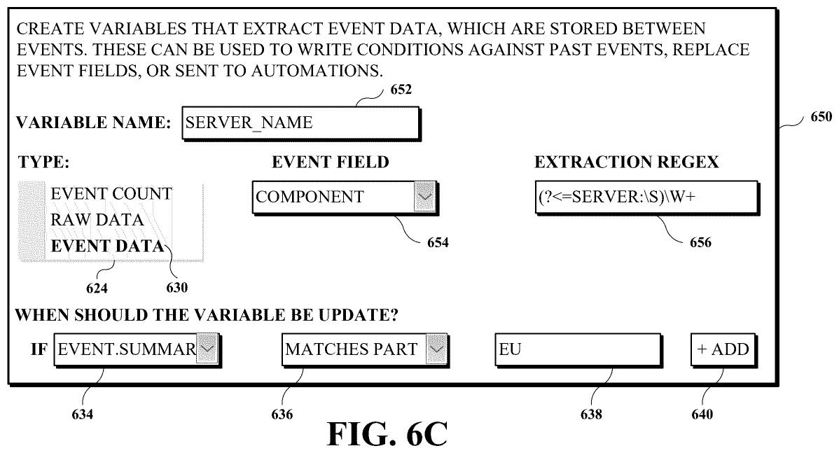

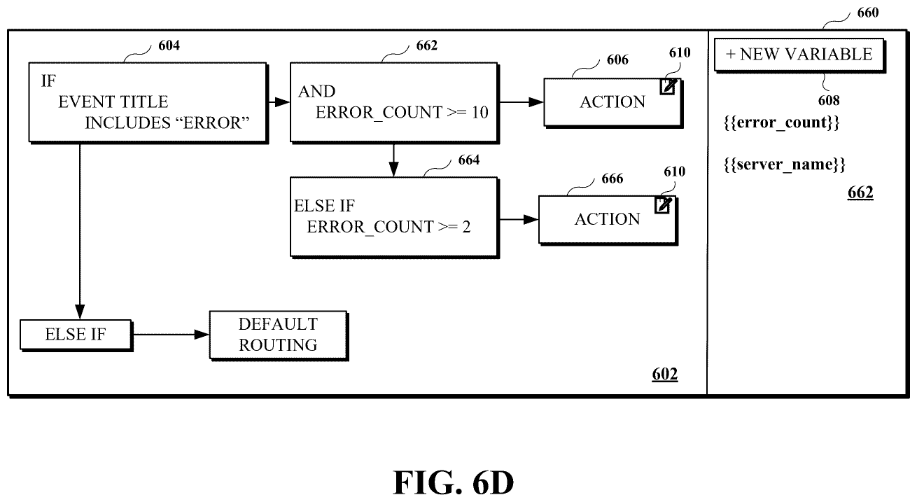

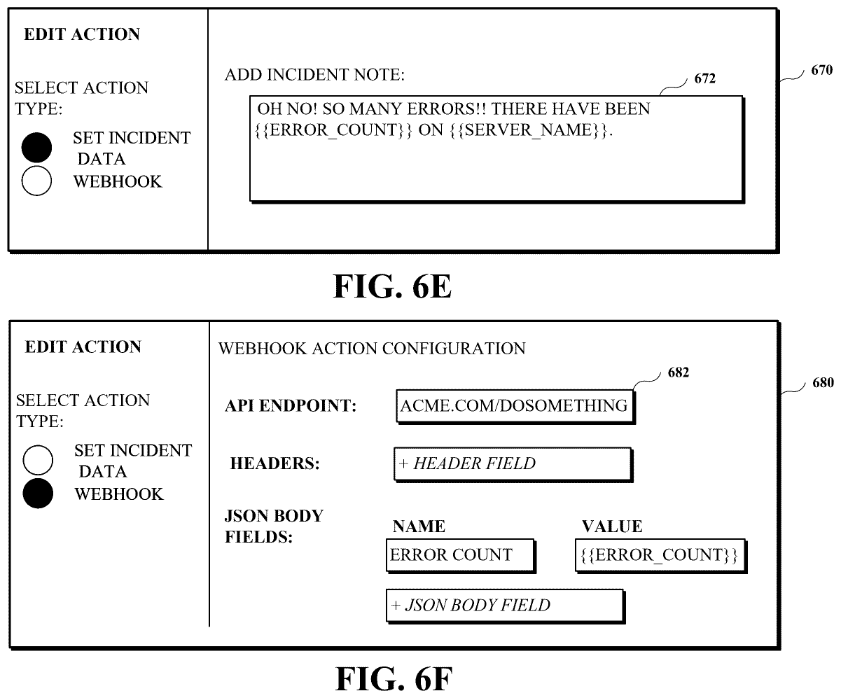

The cached variables software 510 can be used to associate cached variables with one of the ingestion software 506 or the service 508 (collectively, a cached variable holder). In an implementation, a cached variable is scoped to and is only accessible from within the cached variable holder it is associated with. Said another way, a cached variable may only be accessed from an orchestration rule associated with the cached variable holder. An orchestration rule may be a nested orchestration rule. That is, one orchestration rule may use or invoke another orchestration rule (referred to as a child orchestration rule). A cached variable associated with an orchestration rule can also be accessible to child orchestration rules. Via user interfaces of the cached variables software 510, a user may provide a definition (e.g., a description) of a cached variable, such as described with respect to FIGS. 6A-6F.

Definitions of cached variables may be stored in a data store, such as the data store 410 of FIG. 4. The cached variables may be stored in a data store 512, which may be the data store 410 of FIG. 4. A storage handler 514 may implement or manage data writes (e.g., updates) and reads of cached variables in the data store 512. The storage handler 514 may be implemented as or engineered to support horizontal scaling. Horizontal scaling, in this context, refers to the capacity to increase performance and storage capabilities by adding more instances of the storage handler 514 or by distributing the load across multiple servers or storage resources therewith increasing the data handling capacity therewith accommodating a growing number of events and their associated cached variables without degradation in performance.

In some implementations, the cached variables software 510 may use an in-memory data storage system to manage cached variables. In an example, Memcached can be used Memcached is an open source, in-memory key-value store for chunks of arbitrary data (such as strings or objects) from results of, for example, database calls, API calls, or page rendering. Memcached can be used to enhance the performance and scalability of cached variable storage and access. In another example, Redis can be used. Redis is an in-memory data structure store that offers a wide range of data types and features such as persistence, replication, and transactional support, while providing high performance and scalability for managing and accessing cached variables. By utilizing Memcached, Redis, or other in-memory data storage systems, the cached variables software 510 can efficiently handle a high volume of data transactions, facilitating rapid access to and manipulation of cached variables therewith significantly contributing to maintaining high throughput and low-latency data access.

The same orchestration rule may be nearly simultaneously triggered by several incoming events. In some implementations, the cached variables software 510 can implement a locking mechanism designed to manage concurrent accesses and modifications to cached variables, ensuring data consistency and preventing conflicts. When an orchestration rule is activated, the locking system ensures that only one instance can modify the related cached variable at a time.

In other implementations, no locking is implemented, which may result in tolerable data loss. This design decision can be driven by the use case where cached variables may be employed as flags to identify patterns in event streams. In such cases, identifying the occurrence of specific data patterns in an event stream within a given timeframe may be prioritized over complete data accuracy. This approach acknowledges the inevitability of high-volume event handling and opts for a lossy, but functionally sufficient, technique, focusing on the detection of relevant patterns that trigger subsequent checks and actions. An EMB (e.g., the system 400 of FIG. 4) can thus be optimized for fuzzy, timely detection rather than absolute data preservation, aligning with requirements for real-time, event-driven decision making.

To illustrate, assume that a cached variable named error_summary that holds textual (e.g., String) data is used to extract data from event titles based on a pattern that captures a fragment that follows the term “summary:” and extends up to, but not including, the end of a sentence (e.g., summary:\s*([\hat{ }.!?]*[\hat{ }.!?])). When, for example, three new events are received at approximately the same time, the same orchestration rule may be concurrently evaluated three times in three separate threads (e.g., processes, Docker instances, or the like). These instances will read (such as from Memcached or Redis) the current value of error_summary set by a previous event. Based on this value, each instance determines whether to update the error_summary cached variable. In scenarios where multiple instances of the orchestration rule determine to update the error_summary, the instances will race to write to the cache. The final value of the error_summary cached variable will be the one written by the last instance, thereby influencing the subsequent event processing with the most recent data. As such, in this situation, the last writer (e.g., the last instance to update the error_summary) wins (e.g., overwrites the previous writer).

As another illustration, consider a cached variable named error_count, defined as a counter for tracking incoming events with the word “error” in their titles. The cached variable error_count may be associated with an orchestration rule that, in response to receiving 10 such events (i.e., error_count=10) within a minute, transmits a text message alert to a designated responder. In instances where N (e.g., 3) events arrive almost simultaneously, each of the N orchestration rule evaluations might read an initial error_count value (e.g., 0). The N evaluations of the orchestration rule may determine to increment the error_count based on M (e.g., 2) of these events. However, due to absent concurrency controls, this simultaneous processing could lead to an undercount in errors. In this case, error_count may be updated to P<M (e.g., P=1) instead of M because of the ‘last writer wins’ scenario. While this results in a temporary undercount, it is acceptable, particularly in high-volume incoming event environments, as the condition triggering the alert is likely to be met soon regardless. A minor delay in sending the text message notification, such by a few (e.g., single) event, is a trade-off for efficiency in processing large volumes of events. Here, accuracy is sacrificed for improved system performance in event processing.

FIGS. 6A-6F illustrate user interfaces for configuring orchestration rules to use cached variables. The user interfaces of FIGS. 6A-6F can be generated (e.g., rendered) on a display, such as the display 250 of the client computer 200 of FIG. 2, by the combination of the orchestration software 502 and the cached variables software 510 of FIG. 5. While FIGS. 6A-6F illustrate graphical user interfaces, orchestration rules and cached variables may be programmatically configured (e.g., loaded), such as via API calls or the like.

FIG. 6A illustrates a user interface 600 of an orchestration rule editor. As can be appreciated, the orchestration rule editor would typically include many controls and features that enable a user to compose an orchestration rule on a canvas 602. However, for brevity, such controls and features are omitted from FIG. 6A.

The orchestration rule may be associated with an ingestion software or a service, as described with respect to FIG. 5. The orchestration rule is evaluated (e.g., instantiated) for events based on a configuration (not shown) of the orchestration rule. As shown in the user interface 600, a canvas 602 includes a graphical depiction of an orchestration rule. The orchestration rule includes a condition 604 that indicates that if the title of an event for which the orchestration rule is evaluated includes the word “error,” then an action 606 is to be performed (e.g., executed) by the orchestration software 502. It is to be noted, though, that the disclosure herein is not limited to or by any particular orchestration rule conditions or actions. A control 608 can be used to associate cached variables with the orchestration rule. The action 606 can be configured via an edit control 610.

FIG. 6B illustrates a user interface 620 for associating a cached variable with an orchestration rule. The user interface 620 illustrates defining a cached variable, error_count, that tallies the number of events received within a 5-minute window having titles containing the word “error.” The user interface 620 may be rendered in response to a user invoking the control 608 of FIG. 6A and is usable to provide a definition for the cached variable. A field 622 can be used to provide a name for the cached variable. A list 624 lists the available types of cached variables. As shown, the list 624 includes an event count type 626, a raw data type 628, and an event data type 630. Other types are also possible.

The user interface 620 indicates that the event count type 626 is selected for the error_count cached variable. A time window can be associated with a cached variable that has the event count type 626. The time widow can be selected via a control 632.

The user interface 620 also includes controls usable to provide update conditions (e.g., conditional statements) that, when met, result in the cached variable being updated. A control 634 is usable to select a subject (e.g., an aspect of the event) to be evaluated. A control 636 is usable to select a predicate (e.g., a comparison operation) that defines how the subject is compared or evaluated. A control 638 is usable to provide a comparison value, which can be a literal, regular expression, or some other type of comparison value. As such, the conditional statement illustrates in FIG. 6B checks whether the title of the event contains the word “error.” A control 640 is usable to provide additional conditional statements. If no update conditions are associated with a cached variable, then the cached variable will be update based on every event that is processed by the orchestration rule.

The cached variables software 510 implements cached variables defined as counters (e.g., that have or are of the event count type 626) as a data structure of timestamps. The data structure can be an array, a vector, a queue, or some other suitable data structure. Each timestamp is associated with an event that meets the update conditions associated with the cached variable. The timestamp can be the timestamp that the event arrived at (e.g., is ingested by or queued for ingestion) at the ingestion software 506 of FIG. 5. The timestamp can be the time immediately preceding the action of adding the timestamp to the data structure.

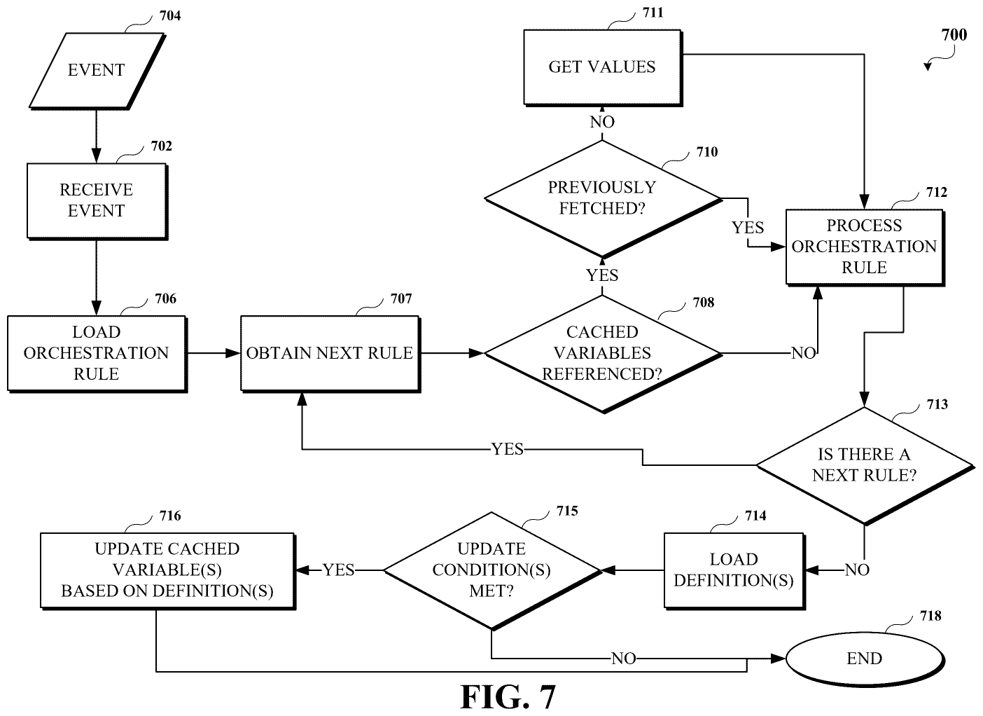

The time window is usable by the cached variables software 510 in determining a value of the cached variable (e.g., how counts are returned), how (e.g., which) timestamps are removed from the data structure, and serves to limit storage requirements. Maintenance of the data structure is further described with respect to FIG. 7.

With respect to returning counts (e.g., a value for the cached variable), the time window defines the period during which events are counted. To illustrate, if the time window is set to 10 minutes, only events that occurred within the last 10 minutes from the time that a value (e.g., the count) of the cached variable is requested are counted towards the value of error_count cached variable.

With respect to the removal of timestamps, the time window can be used to determine which timestamps should be kept in the data structure. Timestamps that fall outside the defined time window are removed. For instance, if the time window is 10 minutes and a timestamp is 15 minutes old, that timestamp will be removed from the data structure.

The time window also serves to limit the storage requirements of the data structure. By removing timestamps that are older than the defined time window, the cached variables software 510 can efficiently manage storage space, ensuring that only relevant, recent events are kept. Accordingly, not only is memory usage optimized, but also performance is enhanced by preventing the data structure from becoming overloaded with outdated data.

FIG. 6C illustrates a user interface 650 for associating a cached variable of event data type with an orchestration rule. The user interface 650 illustrates that the name of the cached variable is server_name and is of the event data type 630. A field 654 is usable to select the event field to be examined for extracting a substring that matches a regular expression provided in a field 656. Event data refers to metadata associated with the event. At least some of the metadata may be associated with the event by the ingestion software 506, the orchestration rule itself, or some other component of the EMB via which the event is processed.

The user interface 650 indicates that the cached variable server_name is to be set from the field named “component” based on the regular expression “(?<SERVER:\s)\w+,” which uses a positive lookbehind (?<SERVER:\s) to find the position right after “SERVER:” and a whitespace character and the \w+ then matches one or more word characters (like letters and numbers) that appear immediately after this position. As such, in the string “SERVER: KUBER1 crash”, it will match and return “KUBER1,” which may be a server identifier. For brevity, the update conditions illustrated in user interface 650 as the same as those used in FIG. 6B.

While no specific user interface is used to illustrate a cached variable that is of the type a raw data type 628, configuring such a cached variable can be similar to the user interface 650 with the exception that the control 634 would include field of the event itself. Additionally, it is noted that cached variables that are of the types raw data type 628 and event data type 630 store textual (String) values.

FIG. 6D illustrates a user interface 650 of an orchestration rule editor where a cached variable is used in a conditional. The user interface 650 illustrates that the cached variable error_count is now incorporated into a condition 662 of a child rule of the condition 604 of FIG. 6A. The condition 662 indicates that the action 606 is to be performed (e.g., executed) by the orchestration software 502 when the event title includes the word “error” and at least 10 events having a title that includes the word “error” were received in the last 5 minutes (as described with respect to FIG. 6B) of the current event being processed. A condition 664 indicates that an action 666 is to be performed when the event title includes the word “error” and two or more events but less than 10 events having a title that includes the word “error” were received in the last 5 minutes.

In an example, if an event does not match a parent rule (e.g., the rule including the condition 604) that does not itself reference cached variables, then cached variables referenced by subsequent conditions may not be fetched. To illustrate, if the title of an event does not include “error,” then the value of the error_count cached variable is not fetched, therewith saving processing time and reducing the read load on the cached variables data store and/or storage handler.

Additionally, cached variable values may be fetched once per orchestration rule. To illustrate, both of the conditions 662 and 664 reference the error_count cached variable. When the condition 662 is evaluated, the error_count value is fetched. But if the error_count does not match the condition 662 and the condition 664 is to be evaluated, the previously fetched value of the error_count variable is used and not fetched again even though between evaluating the condition 662 and the condition 664 another one or more events may have caused the value of error_count to be changed. As such, processing time can be optimized while read load on the cache variables data store and/or storage handler can be reduced.

FIG. 6E illustrates an example of a user interface 670 for configuring the action 606 of FIG. 6D to use a cached variable. The user interface 670 may be rendered in response to an invocation of the edit control 610 of FIG. 6D. The user interface 670 illustrates that the action 606, when performed by the orchestration software 502 adds a note to the event currently being processed based on a note configuration 672 where the note includes values (e.g., interpolations) of the cached variables error_count and server_name described above. The double braces surrounding the cached variable names in the note configuration 672 direct the orchestration software to replace the placeholders {{error_count}} and {{server_name}} with actual values of these cached variables.

FIG. 6F illustrates another example of a user interface 680 for configuring the action 606 of FIG. 6D to use a cached variable. The user interface 680 may be rendered in response to an invocation of the edit control 610 of FIG. 6D. The user interface 680 illustrates that the action 606, when performed by the orchestration software 502, causes an HTTP request to be transmitted to an endpoint configured in a field 682. The user interface 680 illustrates that values of cached variables can be included in a JSON payload of the HTTP request. Specifically, the user interface 680 illustrates that the JSON payload is to include a key-value pair where the key is “error count” and the value is obtained from the cached variable error_count.

FIG. 7 is an example of a technique 700 for using cached variables in orchestration rules. The technique 700 can be implemented, for example, as a software program that may be executed by one or more computing devices, which can be similar to the network computer 300 of FIG. 3. The software program can include machine-readable instructions that may be stored in one or more memories, which can be one or more of the processor-readable stationary storage device 334 or the processor-readable removable storage device 336 of FIG. 3, and that, when executed by one or more processors, such as the processor 302, may cause the one or more computing devices to perform the technique 700. The technique 700 may be implemented in whole or in part by the system 400 of FIG. 4. The technique 700 can be implemented in whole or in part by the orchestration software 502 and/or the variables software 510 of FIG. 5. The technique 700 can be implemented using specialized hardware or firmware. Multiple processors, memories, or both, may be used.

At 702, an event 704 is received. The event may be received at or by the ingestion software 506 or the service 508 of FIG. 5. At 706, an orchestration rule configured to process (e.g., to be evaluated with respect to) the event is loaded, such as from the data store 410 of FIG. 4. Loading the orchestration rule can include loading any sub- (e.g., child or nested) orchestration rules and definitions of cached variables associated with the loaded orchestration rule(s).

As mentioned herein, an orchestration rule may be hierarchical and may include other rules (e.g., may be a tree of orchestration rules). As such, at 707, a next orchestration rule may be obtained from the orchestration rule. At 708, the orchestration rule is parsed to determine whether any conditions therein, such as the condition 604 of FIG. 6A or the conditions 662 and 664 of FIG. 6D, reference any of the cached variables. The technique 700 also determines whether any actions of the orchestration rule, such as the action 606 of FIG. 6D, reference any of the cached variables. If no cached variables are used in conditions or actions, the technique 700 proceeds to 712. On the other hand, if any cached variables are used in the orchestration rule, then, at 710, the technique 700 determines whether the values of the referenced cached variables have already been fetched with respect to the orchestration rule loaded at 706.

If referenced cached variables have already been fetched, then the technique 700 proceeds to 712; otherwise, at 711, the technique 700 obtains the respective values of the cached variables not already fetched. The respective values can be obtained via (e.g., by querying) the storage handler 514 of FIG. 5. From 711, the technique 700 proceeds to 712. At 712, the orchestration rule is processed. At 713, the technique 700 determines whether another (e.g., a child) rule is to be processed. If so, the technique 700 proceeds back to 707; otherwise, the technique 700 proceeds to 714 to load the definitions of the cached variables to determine whether update conditions are associated with any of them.

At 715, the technique 714 determines whether any of the cached variables are to be updated. The technique 700 determines whether a cached variable is to be updated based on the definition of the cached variable. That is, the technique 700 evaluates the update conditions associated with the cached variable based on the event 704 (e.g., based on data of the event, metadata received with the event, or any data added to the event by the orchestration rule itself). If no update conditions associated with any of the cached variables are met, then the technique 700 ends at 718.

If update conditions associated with a cached variable are met, then the cached variable is updated, at 716. A cached variable that is a String (e.g., is defined as being of the raw data type 628 or the event data type 630) is updated by extracting the identified value, such as described with respect to FIG. 6C and saving the extracted value via a request to a storage handler, such as the storage handler 514 of FIG. 5. Updating a cached variable that is a counter (e.g., is defined as being of the event count type 626) can include, as described above, adding a timestamp to a data structure associated with the cached variable. Additionally, timestamps that do not fall within the defined time window are removed.

The data structure associated with a counter cached variable can be updated to remove timestamps that do not fall within the defined time window every time that a timestamp is added to the data structure. In another example, the process of updating a cached variable that is a counter may involve periodically checking the timestamps in the data structure. The periodic evaluation can be scheduled at regular intervals or triggered by specific events (e.g., every N^{th} insertion of a timestamp, where N>1). During this check, timestamps outside the time window, based on the time that the evaluation is performed, are identified and removed. To illustrate, assuming that the time window for the cached variable is set to 5 minutes, if the periodic evaluation is performed at 12:05:00, then any timestamps in the data structure that are from before 12:00:00 would be removed.

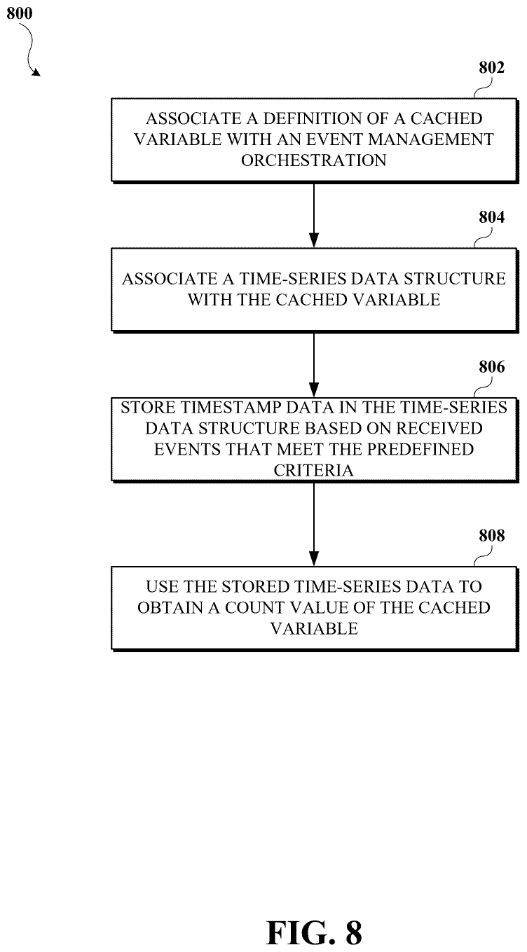

To further describe some implementations in greater detail, reference is next made to examples of techniques which may be performed by or using a system that uses cached variables to inject contextual memory into event processing. FIG. 8 is a flowchart of an example of a technique 800 for using time series as a counter in event management. The technique 800 can be executed using computing devices, such as the systems, hardware, and software described with respect to FIGS. 1-7. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof. The steps of the technique 800 can be distributed (e.g., performed) using multiple processors, memories, or both. The technique 800 can be implemented at least in part by a cached variables software, such as the cached variables software 510 of FIG. 5.

At 802, a definition of a cached variable is associated with an event management orchestration. The definition of the cached variable can be associated with the event management orchestration as described with respect to FIGS. 6A-6F. As described above, the definition can identify the cache variable as a counter of events that meet predefined criteria (i.e., update conditions). At 804, a time-series data structure is associated with the cached variable.

At 806, timestamp data (i.e., timestamps) are stored in the time-series data structure based on received events that meet the predefined criteria. At 808, the stored time-series data are used to obtain a count value of the cached variable. The count value can be used by the event management orchestration to determine a processing or a subsequent event to the received events, as described herein.

Storing the timestamp data in the time-series data structure based on the received events that meet the predefined criteria can include, as described with respect to FIG. 7, prior to processing a received event via the event management orchestration, determining that the cached variable is referenced in the event management orchestration and obtaining the count value of the cached variable. The event is then processed via the event management orchestration, after processing the event, the time-series data structure is updated based on the received event. That is, if the event meets the predefined criteria, then then the data structure is updated by adding a timestamp associated with the event to the data structure. As such, the time-series data structure can be updated based on a time window associated with the cached variable.

As further described herein, some cached variables can be defined as storing textual data. As such, in an example, the technique 800 can include storing, in another cached variable, textual data extracted from the received event prior to processing the received event via the event management orchestration. The textual data can be extracted from the received event based on a regular expression. The textual data can be extracted from a payload of the received event. The textual data can be extracted from metadata associated with the received event.

For simplicity of explanation, the techniques 700 and 800 of FIGS. 7 and 8, respectively, are each depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PUP, Perl, JavaScript, Ruby, VBScript, Microsoft .NET™ languages such as C#, and/or the like. A software may be compiled into executable programs or written in interpreted programming languages. Software may be callable from other software or from themselves. Software described herein refer to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
associating a definition of a cached variable with an event management orchestration, wherein the definition identifies the cached variable as a counter of events that meet predefined criteria;
associating a time-series data structure with the cached variable;
storing timestamp data in the time-series data structure based on received events that meet the predefined criteria; and
using the stored time-series data to obtain a count value of the cached variable, wherein the count value is used by the event management orchestration to determine a processing or a subsequent event to the received events.

2. The method of claim 1, wherein storing the timestamp data in the time-series data structure based on the received events that meet the predefined criteria comprises:
identifying the event management orchestration in response to a received event;
prior to processing the received event via the event management orchestration:
determining that the cached variable is referenced in the event management orchestration; and
obtaining the count value of the cached variable;
processing the received event via the event management orchestration; and
after processing the received event, updating the time-series data structure based on the received event.

3. The method of claim 2, further comprising:
storing, in another cached variable, textual data extracted from the received event prior to processing the received event via the event management orchestration.

4. The method of claim 3, wherein the textual data are extracted from the received event based on a regular expression.

5. The method of claim 3, wherein the textual data are extracted from a payload of the received event.

6. The method of claim 3, wherein the textual data are extracted from metadata associated with the received event.

7. The method of claim 2, wherein updating the time-series data structure based on the received event comprises:
updating the time-series data structure based on a time window included in the definition.

8. A system, comprising:
one or more memories; and
one or more processors, the one or more processors configured to execute instructions stored in the memory to:
associate a definition of a cached variable with an event management orchestration, wherein the definition identifies the cached variable as a counter of events that meet predefined criteria;
associate a time-series data structure with the cached variable;
store timestamp data in the time-series data structure based on received events that meet the predefined criteria; and
use the stored time-series data to obtain a count value of the cached variable, wherein the count value is used by the event management orchestration to determine a processing or a subsequent event to the received events.

9. The system of claim 8, wherein the instructions to store the timestamp data in the time-series data structure based on the received events that meet the predefined criteria comprises instructions to:
identify the event management orchestration in response to a received event;
prior to processing the received event via the event management orchestration:
determine that the cached variable is referenced in the event management orchestration; and
obtain the count value of the cached variable;
process the received event via the event management orchestration; and
after processing the received event, update the time-series data structure based on the received event.

10. The system of claim 9, wherein the one or more processors are further configured to execute instructions stored in the one or more memories to:
store, in another cached variable, textual data extracted from the received event prior to processing the received event via the event management orchestration.

11. The system of claim 10, wherein the textual data are extracted from the received event based on a regular expression.

12. The system of claim 10, wherein the textual data are extracted from a payload of the received event.

13. The system of claim 10, wherein the textual data are extracted from metadata associated with the received event.

14. The system of claim 9, wherein the instructions to update the time-series data structure based on the received event comprises instructions to:
update the time-series data structure based on a time window included in the definition.

15. Non-transitory computer readable media storing instructions operable to cause one or more processors to perform operations comprising:
associating a definition of a cached variable with an event management orchestration, wherein the definition identifies the cached variable as a counter of events that meet predefined criteria;
associating a time-series data structure with the cached variable;
storing timestamp data in the time-series data structure based on received events that meet the predefined criteria; and
using the stored time-series data to obtain a count value of the cached variable, wherein the count value is used by the event management orchestration to determine a processing or a subsequent event to the received events.

16. The non-transitory computer readable media of claim 15, wherein storing the timestamp data in the time-series data structure based on the received events that meet the predefined criteria comprises:
identifying the event management orchestration in response to a received event;
prior to processing the received event via the event management orchestration:
determining that the cached variable is referenced in the event management orchestration; and
obtaining the count value of the cached variable;
processing the received event via the event management orchestration; and
after processing the received event, updating the time-series data structure based on the received event.

17. The non-transitory computer readable media of claim 16, the operations further comprising:
storing, in another cached variable, textual data extracted from the received event prior to processing the received event via the event management orchestration.

18. The non-transitory computer readable media of claim 17, wherein the textual data are extracted from the received event based on a regular expression.

19. The non-transitory computer readable media of claim 17, wherein the textual data are extracted from a payload of the received event.

20. The non-transitory computer readable media of claim 17, wherein the textual data are extracted from metadata associated with the received event.
